(19) United States
(12) Patent Application Publication
(10) Pub. No.: US 2026/0180705 A1
(43) Pub. Date: Jun. 25, 2026

(54) Method and System for Time Synchronization of Sensor Units

(71) Applicant: Siemens Aktiengesellschaft, Muenchen (DE)

(72) Inventors: Jaroslaw KUSSYK, Wien (AT); Josef BRANDSTETTER, Wien (AT)

(21) Appl. No.: 19/424,390

(22) Filed: Dec. 18, 2025

(30) Foreign Application Priority Data
Dec. 19, 2024 (EP) 24221620

(51) Int. Cl. H04J 3/06

(52) U.S. Cl. CPC H04J 3/0661; H04J 3/0617; H04J 3/0623

(57) ABSTRACT

A method for time synchronization of sensors in a distributed system, wherein an up-to-date value of an internal time unit of a sensor is stored when capturing sensor data, at least the value of the internal time unit stored when a characteristic time feature of an identification signal is received, an associated transmitter identification of the identification signal and a further value of the internal time unit is transferred together with the sensor data to the central unit, and where the central unit captures voltage and phase values from at least one phase conductor of a power grid as the current pointer over more than one measuring period, and the current pointers of the respective sensor unit are aggregated to form aggregated current pointers that are transferred to the central unit, and correct-phase powers are calculated from the voltage values and the aggregated current pointers in the central unit.

### BACKGROUND OF THE INVENTION

### 1. Field of the Invention

The invention relates to a method and a system for the time synchronization of sensor units in a distributed system.

### 2. Description of the Related Art

In electrical energy distribution infrastructure, such as in intelligent direct current and alternating current distribution grids, i.e., “smart grids”, the information about a grid state, such as the voltage level, the current load, the power flow and/or the load distribution, are captured and determined by a large number of distributed sensor data. In order to monitor and control the grids, the sensor data is customarily transmitted and centrally evaluated.

Depending on the type of sensor and the type of central evaluation of the sensor data, the sensor value and the instant of capture are important for the evaluation in order, for example, to enable a calculation of active and reactive power based on voltage and current measured values, which can be transmitted by different sensors, which can also be locally distributed.

The exact instant of capture of the measured values and, in particular, their relation to one another is essential, in particular, for the determining the active and reactive power of the complex apparent power.

In the prior art, the temporal synchronization is/was achieved by grid-bound communications links between the sensors and the evaluation unit or the voltage measured value was supplied as an analog measured value signal to the individual current measuring sensors via a wired connection.

As a wireless alternative solution, the use of an additional time synchronization source in each sensor is known, which source is available via a radio link, for example a GPS clock, a radio time standard transmitter (such as the long-wave transmitter DCF77) or a central “Network Time Protocol” (NTP) reference time server.

The drawback of wired communication solutions is that a data line is necessary, and this could result in increased installation effort and lower acceptance by the users and this can be a relevant cost factor and system complexity factor, particularly when retrofitting the sensors.

The drawback of time synchronization sources via radio is the limitation of the installation position of the antenna. Thus, for example, receipt of GPS/DCF77/mobile radio signals in closed spaces is very difficult to impossible.

In addition, DCF77 or comparable time information services are not sufficiently accurate and have only limited regional availability.

In addition, such solutions cause an undesirable system complexity, unfavorable installation instructions and result, moreover, in increased costs due to an additional radio receiver and the associated antenna.

Publication EP3993290B1 discloses a method for time synchronization of sensor units of a distributed system, via which a temporal relationship between the captured sensor data of the sensor units of the distributed system can be established, although internal signal propagation delays are accordingly not taken into account during the signal capture, whereby the accuracy when determining a power consumption in an energy distribution grid is adversely impaired.

A further problem is present in the prior art if sensors are to transmit the captured current data or voltage data via a distributed medium, such as a radio grid with limited transmission capacity, such as Bluetooth, Bluetooth Low Energy (BLE), and/or ZigBee. The problem can arise here that the individual current samples or voltage samples, in particular from several dozen such sensors, result overall in an excessive volume of data for the transmission medium.

In the prior art, the problem of a large volume of measurement data was solved such that, for a specific measuring period, current and/or voltage effective values were formed in distributed sensors and transferred into an evaluation unit instead of their individual samples being transferred.

The drawback of these methods in a locally distributed separate formation of alternating current and/or alternating voltage effective values consists in that the information about the phasing of the alternating current in a conductor is lost in relation to the associated alternating voltage, whereby the calculation of active and reactive power is not possible which, however, would be essential to monitor a load flow in an alternating current distribution grid.

### SUMMARY OF THE INVENTION

In view of the foregoing, it is therefore an object of the invention to provide a simpler, efficient, accurate and reliable solution to data transfer of sensor data from distributed sensors.

This and other objects and advantages are achieved in accordance with the invention by a method for time synchronization of sensor units in a distributed system, where the sensor units have one internal time unit respectively, and where sensor data is captured by the sensor units and transmitted to a central unit via a radio grid, and an identification signal is emitted at regular intervals in the radio grid. In accordance with the method, receipt of the identification signal is monitored in a respective sensor unit, where when a characteristic time feature of the identification signal is received, one up-to-date value respectively of the internal time unit of the respective sensor unit is stored with at least one transmitter identification contained in the identification signal, where when capturing sensor data, a further, up-to-date value of the internal time unit of the respective sensor unit is stored, where at least the value of the internal time unit stored when the characteristic time feature of the identification signal is received, the associated transmitter identification of the identification signal, and the further value of the internal time unit stored when capturing the sensor data is assigned to the captured sensor data and is transmitted together with the sensor data to the central unit, and where using the transmitter identification, a reference time basis and using the value of the internal time unit of the respective sensor unit stored when the characteristic time feature of the identification signal is received and the further value of the internal time unit of the respective sensor unit stored when the sensor data is captured, a temporal relationship of the transmitted sensor data of the respective sensor unit to the reference time basis is derived, and where the central unit captures voltage values and phase values from at least one of the three phase conductors of a power grid as voltage pointers over more than one fundamental oscillation period of the voltage, and the sensor data as current pointers of the respective sensor unit is aggregated to form aggregated current pointers, and instead of the sensor data, the aggregated current pointers are transmitted to the central unit, and in the central unit correct-phase powers are calculated from the voltage values and the aggregated current pointers.

Consequently, it is advantageously possible to merge the complex values of the current pointers and reduce the data in the transmission channel from the sensor unit to central unit.

The volume of data of the transmission from the respective sensor unit to the central unit can thus be reduced and the transmission channel can be efficiently used accordingly.

An aggregation of alternating current pointers or alternating voltage pointers allows a drastic reduction in the volume of measurement data that is to be transmitted to a central unit in a distributed measuring system of a plurality of sensor units.

A sufficiently accurate calculation of active and reactive power mean values is nevertheless possible for load flow monitoring in electrical alternating current distribution grids.

Consequently, it is possible to employ energy-saving wireless communication technologies, and this is very advantageous particularly in the case of solutions with local energy recovery from the currents in individual phase conductors.

After a complex alternating current pointer or the aggregated value has been received, by taking into account its assignment to the corresponding phase voltage, the complex alternating current pointer or the aggregated value can either be adopted directly, or rotated about ±120°, before it is multiplied by the amount of the associated, i.e., the corresponding, phase voltage to calculate the active and reactive power with the correct phase.

An aggregated value is taken to mean a mapping of a plurality of measured values to a single value, such as via averaging, in particular averaging from a plurality of current and/or voltage pointers, from which aggregated current or voltage pointers are formed by the averaging.

The correct-phase calculation of powers is taken to mean that voltages and currents from a plurality of phasing lines are brought into the appropriate phasing before a multiplication, therefore are rotated or transformed in the appropriate direction accordingly about an angle of ±120°.

It is clear that the powers are calculated in the central unit from the voltage values or their (aggregated) voltage pointer values and the aggregated current pointers.

The correct-phase calculation of powers can thus be referred to as a power calculation by taking into account a transformation of the individual phases of the (aggregated) current pointers in relation to the phasing of a selected reference voltage.

In other words, the voltages and currents from a plurality of phasing lines have to be brought into a phasing in order to have the same reference as the associated voltage pointers to the X-axis of a 2-dimensional Cartesian coordinate system, in which the associated complex-value current pointers and voltage pointers are represented, as graphically represented in FIGS. 1, 2 and 3.

The transformation can occur on two different variants:
a) One voltage pointer is defined as a reference voltage, which determines a coordinate system for all voltage and current pointers, jointly in the central unit as well as in the sensor unit via the synchronization.
b) In this case, direction and orientation of the reference voltage pointer correspond to the X-axis of a Cartesian coordinate system, and voltage pointer as well as current pointer are based on the same coordinate system, which is determined by the up-to-date reference voltage pointer, and therefore do not have to be rotated.
   If a new reference voltage pointer is defined, direction and orientation of the X-axis and Y-axis of a Cartesian coordinate system is changed accordingly, i.e. rotated.
   In that case, voltage pointers as well as current pointers again refer to the same coordinate system and therefore do not have to be rotated.
   However, voltage pointers as well as current pointers are represented differently as complex values in the preceding and in the rotated coordinate system and can have different complex values).
c) Each of the three voltage pointers—preferably phase voltage pointers—forms its own coordinate system, and only those current pointers that pertain to the respective voltage pointers that are currently not the reference voltage pointer or are rotated by the reference voltage pointer about +/−120° accordingly, have to be rotated about +/−120°.

The alternating current pointer as a vector, which is determined in the Cartesian coordinate system by its complex value, can be rotated, for example, via multiplication by what is known as a rotation matrix.

The aggregated alternating current pointers can accordingly be transmitted from the sensor unit to the central unit with the aid of a radio link, alongside time stamps of the sensor unit, the respective numbers of the first fundamental oscillation period of the reference voltage in the measuring period, and optionally the numbers of the up-to-date measuring period p and/or the preceding measuring periods p−1, p−2.

After this data has been received, the associated, synchronously captured, complex aggregated alternating current pointers can be rotated about a respective angle of 120° in the appropriate direction in the central unit in order to obtain a correct phase reference to the appropriate phase voltage or to the reference voltage for this sensor unit.

The rotated, aggregated alternating current pointer can then be multiplied by the amount of the (aggregated) effective value of the phase voltage in order to obtain mean values for the active and reactive power, and this corresponds to the previously mentioned variant b).

Alternatively, it would also be possible to conjugate the complex aggregated alternating current pointer and multiply it by the associated complex, aggregated alternating voltage pointers in order to obtain the mean values for active and reactive power, and this corresponds to the previously mentioned variant a).

In order to therefore reduce the volume of measurement data to be transferred, the current pointers can be averaged as complex values over the measuring period and be stored as aggregated complex alternating current pointers.

In one embodiment of the invention, the current pointers are aggregated by taking into account their respective amounts, including the phase values, by averaging within the measuring period, for example, by separate averaging of the real and imaginary parts of the complex values of the current pointers. Consequently, an aggregation, which can be carried out in the sensor unit with a low calculation complexity, is easily achieved.

In another embodiment of the invention, the current pointers are aggregated by taking into account the respective internal time unit of the respective sensor unit by averaging over the measuring periods. Consequently, an alternative aggregation, which can be performed by the sensor unit with a low calculation complexity, is easily achieved.

In a further embodiment of the invention, the aggregation of the current pointers takes into account only those periods in which the values for the current pointers lie within predefined limit values. Consequently, the accuracy and reliability of the measured values, which are used in the subsequent power calculation, can be improved. Therefore only the valid measured current pointers are used during the aggregation over the measuring period.

Those current pointers that are falsified, for example, due to an occurrence of interference pulses or energy recovery phases, are not incorporated in the aggregation within the measuring period. Here the effective duration for the aggregation within the measuring period is reduced, or the valid current pointers used for the aggregation form a fragmented volume.

Time periods, in which the currents are disrupted in a sensor unit by an energy recovery, can be signaled by a current supply unit within the sensor unit and can be excepted from the aggregation, and this can result in a further fragmentation of the aggregation.

In another embodiment of the invention, the aggregated current pointers are transferred from the respective sensor unit to the central unit.

In an embodiment, the current pointers are ascertained over more than one fundamental oscillation period of the reference (phase) voltage, i.e., over more than one voltage period of one of the three phases of the power grid, preferably from at least ten periods, particularly preferably from at least 100 periods. Consequently, an efficient aggregation, that can be performed by the sensor unit with a low calculation complexity, is easily achieved.

In another embodiment of the invention, the central unit captures voltage values and phase values from at least one of the three phase conductors of a power grid, from which synchronization data on the frequency or period duration, as well as on the phasing of the voltage of at least one of the three phase conductors in relation to the instant of capture of the voltage values and phase values of the at least one of the three phase conductors is ascertained and transmitted to the sensor units, and the respective sensor unit captures the respective sensor data in the form of current values in relation to the synchronization data, where the sensor data is transferred to the central unit, and powers are calculated in the central unit from the voltage values and current values.

Consequently, a synchronous power measurement is enabled with the aid of radio-based current-measuring sensors and a shared central voltage-capturing unit, and this allows a flexible and efficient subsequent installation and expansion of devices to monitor electrical energy distribution grids without increased cabling effort. The synchronous measurement of the power of the consumer system easily allows a particularly precise measurement.

It is clear that powers are calculated in the central unit from the voltage values and current values by including their respective phasing. This is achieved because the voltages in the power grid are measured only at one location and the currents are captured at a plurality of distributed locations. This is less laborious in practice than capturing additional voltages at distributed sites, because a higher protection effort would be necessary and, furthermore, the overvoltage problem would also have to be solved.

In addition, no additional synchronization source and no additional cabling are necessary with the decentral active and reactive power measurement. The synchronization can occur, for example, because a time basis of a leading timer within the central unit is coordinated with a correspondingly following time basis of the respective sensor unit.

The current flowing through the sensor unit can also be used for the energy supply thereof, and this allows particularly simple subsequent and low-maintenance integration in an existing system. For example, a synchronization frame of a communication, in particular a communication to a plurality of receivers (“multicast”), can be applied under the identification signal.

In at least one or all sensor unit(s), zero point crossing instants of the reference voltage are synchronously determined in the central unit in the up-to-date measuring period using the transmitted values for the zero point crossing and the period duration, and the optional value for the zero point crossing of the preceding period, and based on the alternating current values, firstly current pointers are formed for each individual voltage fundamental oscillation period within the up-to-date measuring period.

In an embodiment of the invention, the synchronization data relating to the phasing of the voltage of at least one of the three phase conductors in relation to the instant of capture of the voltage values and phase values of the at least one of the three phase conductors is formed by the instant of transmission from the central unit to the respective sensor unit. Consequently, synchronization data for compensating for the delay can be ascertained and transferred particularly easily.

In a further embodiment of the invention, the synchronization data is transmitted to the sensor units with the aid of the identification signal. Consequently, the synchronization data for compensating for the delay can be transferred, or the time basis in the sensor unit can be adjusted, particularly easily.

In a further embodiment of the invention, the synchronization data is ascertained over more than one period of the voltage values and phase values of the three phases of the power grid, preferably from at least ten periods, particularly preferably from at least 100 periods. Consequently, the radio channel is stressed less, less data is transferred and adequate accuracy of the power measurement in the power grid is nevertheless obtained.

In one embodiment of the invention, the central unit captures voltage values and phase values from a phase conductor of the power grid and first supplementary synchronization data on the time delay when the identification signal is emitted, which was captured in a preceding timeframe, which lies before the up-to-date timeframe in which the synchronization data is captured, and the first supplementary synchronization data is transmitted to the respective sensor unit, preferably with the aid of the identification signal, and the first supplementary synchronization data is taken into account by the respective sensor unit when capturing the respective sensor data. Consequently, the measuring accuracy can be easily improved.

In addition, synchronization data for compensating for the delay can be ascertained and transferred particularly easily.

The first supplementary synchronization data is the value of the time delay in the preceding measuring cycle. Firstly, the synchronization data in the form of the zero point crossing instant in the central control apparatus as well as the period duration in the phase conductor is transferred. Only afterwards is the captured delay of the emission of the synchronization frame subsequently transferred at the start of the next, following measuring period. The phase conductor of the power grid is a selected reference conductor of the three phasing lines, which is applicable as a reference for the phasings of the further phase conductors.

In another embodiment of the invention, the central unit also has an internal central time unit whose value forms second supplementary synchronization data, and the second supplementary synchronization data is transmitted to the respective sensor unit, preferably with the aid of the identification signal, and the respective sensor unit takes the second supplementary synchronization data into account when the respective sensor data is captured. Consequently, the measuring accuracy can be easily improved. In addition, synchronization data for compensating for the delay can be ascertained and transferred particularly easily.

The objects and advantages are also achieved in accordance with the invention by a distributed system for the time synchronization of sensor units, also comprising a central unit, where the system is configured to execute the inventive method in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail in the following figures on the basis of exemplary embodiments, in which:

FIGS. 1-3 show examples of adjusting the phasing of voltage or current pointers to a reference phase line with the reference voltage thereof;

FIG. 4 shows an exemplary energy distribution grid;

FIG. 5 shows a first block diagram of an exemplary embodiment of the invention;

FIG. 6 shows a second block diagram of an exemplary embodiment of the invention;

FIG. 7 shows a third block diagram of exemplary embodiment of the invention;

FIG. 8 shows a detailed view of the central unit in accordance with the invention;

FIG. 9 shows an exemplary signal characteristic in the energy distribution grid; and

FIG. 10 is a flowchart of the method in accordance with the invention.

### DETAILED DESCRIPTION OF THE EXEMPLARY EMBODIMENTS

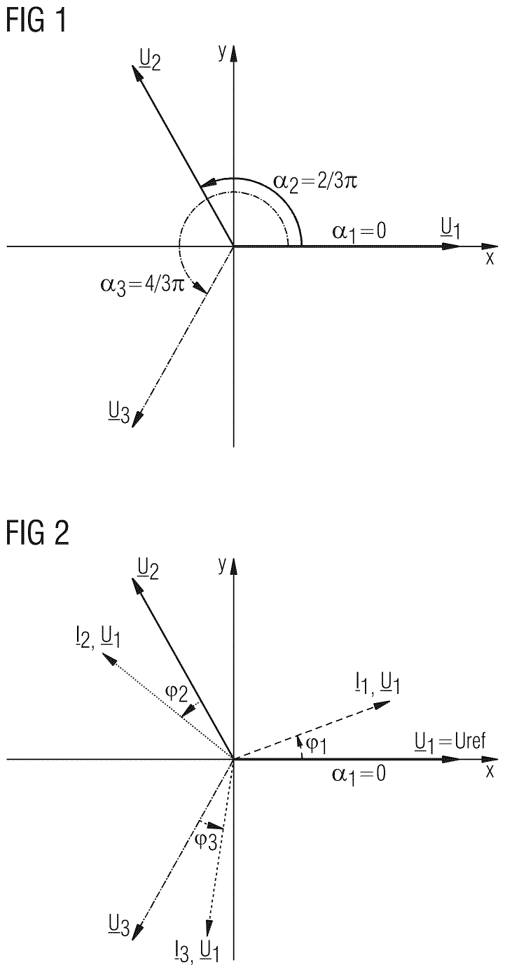

FIG. 1 shows an example of voltage pointers of an energy distribution grid with a phasing of 120° relative to each other.

FIG. 2 shows an example of voltage pointers and current pointers of an energy distribution grid.

The voltage pointers have a phasing of 120° (⅔π) relative to one another, with the first voltage pointer U₁ being selected as the reference voltage U_{REF} which lies on the X-axis of the graph.

The current pointers have a phasing φ₁, φ₂, φ₃ to the respective assigned voltage pointers, and this is caused by different loads on the phasing lines.

FIG. 3 shows an example of voltage pointers and current pointers of an energy distribution grid.

The voltage pointers again have a phasing of 120° relative to one another, with the second voltage pointer U₂ being selected as the reference voltage U_{REF} which does not lie on the X-axis in the graph.

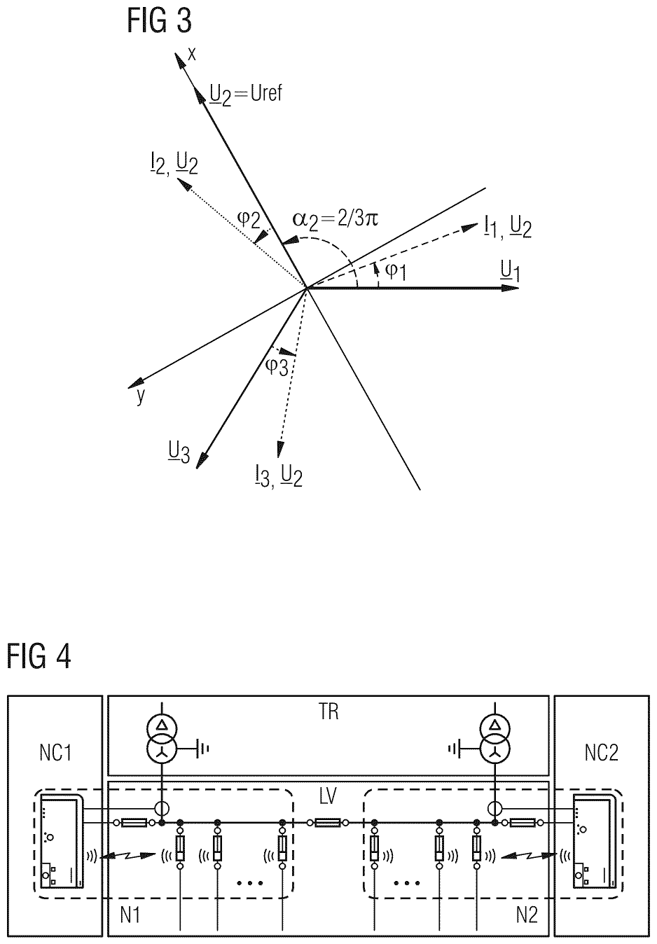

FIG. 4 shows an example of an energy distribution grid in the form of a “single-line” circuit diagram.

The lines represent 3-, 4- or 5-conductor connections of individual branches in the low-voltage and medium-voltage range (customary designations are L1, L2, L3 or L1, L2, L3, PEN/E or L1, L2, L3, N and PE/E).

A sensor unit and/or a central unit can be installed in each of the cited conductors as well as in the medium-voltage branches/range.

A high voltage is converted into a low-voltage range LV with the aid of one or more transformer(s) TR in what is known as a local grid station.

Central units are connected to respectively assigned sensor units via respective wireless networks N1, N2, which are controlled via correspondingly assigned network control apparatuses NC1, NC2.

A sensor unit serves for capturing currents in the phase conductors of individual branches to end consumers.

In the sensor unit(s), which is/are installed as low voltage high performance sets of fuses or, for example, in the medium-voltage lines/branches, current pointers, i.e., complex values for the respective currents are captured as current values or sensor data, with a mean value optionally being formed for the ascertained currents and this value being transferred.

What are known as time-synchronized current pointers are applied that are captured synchronously with voltage pointers at a specific instant.

With the currents, the mean values of the current pointer or current amounts/amplitudes or current effective values can be used because the mean values of the alternating currents are frequently close to zero.

In the central unit, voltage pointers, i.e., complex values for the respective voltages, are captured as voltage values, with a mean value optionally being formed for the ascertained voltages.

What are known as time-synchronized voltage pointers can be applied that are captured synchronously with current pointers at a specific instant.

With the voltages, the mean values of the voltage pointers or voltage amounts/amplitudes or voltage effective values can be used because the mean values of the alternating voltages are frequently close to zero.

In the central unit, the averaged current pointers are received by one or more sensor unit(s) via a short-range radio communication (such as “Zigbee” or Bluetooth).

By including the associated averaged voltage pointers, the active and reactive power P and Q in the respective phasing lines is calculated in the central unit.

Pointers for current or voltage are taken to mean respective complex values, i.e., amount values and phase values for the current or the voltage.

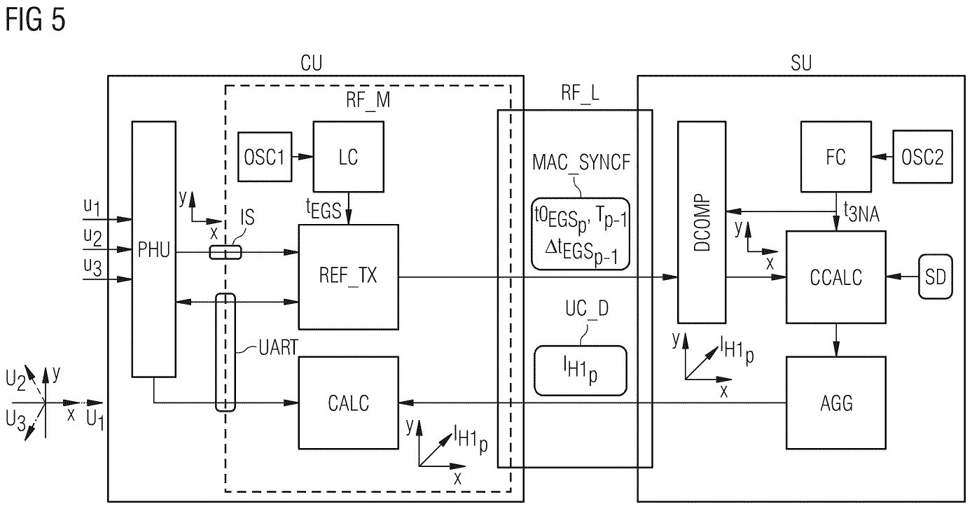

FIG. 5 shows a first exemplary block diagram of embodiment of the invention.

A central unit CU comprises an apparatus for reference phase transfer PHU, which serves for:
a detection of a zero crossing in a voltage characteristic,
a calculation of voltages with items of amount and phase information, i.e., voltage pointers,
counting measuring periods p of a respective reference voltage U_{REF_H1}, selected from the grid voltages u1, u2, u3, which are preferably phase voltages,
a determination of a reference conductor LREF from grid phase conductors L1, L2, L3 of a power grid,
a determination of a phase sequence of grid voltages u1, u2, u3 in the form of voltage pointers U1, U2, U3 of the grid voltage.

A measuring period p can be regarded as a period that can also last more than one grid voltage period, which can also be referred to as a voltage fundamental oscillation period, which is then counted accordingly.

The voltage fundamental oscillation is often referred to as the first harmonic, or as “H1” for short, of the grid voltage.

The data of the apparatus for reference phase transfer PHU is distributed accordingly to a radio-frequency module RF_M with the aid of a transmitter or receiver UART, or via an internal interface, such as a serial interface, in the central unit CU.

An interrupt signal IS for the zero crossing of the reference voltage U_{REF_H1} is supplied to a reference signal transmitter REF_TX within the radio-frequency modules RF_M which, in turn, receives an item of information in respect of a time delay Δt_{EGS} from a central oscillator OSC1 and a connected leader clock LC.

The time delay Δt_{EGS} at the beginning of a measuring period p is a delay between the instant t0_{EGSp} of activation of the interrupt signal IS, i.e., for the zero crossing of the reference voltage U_{REF_H1}, and the instant t_{EGS_SYNCp} of emission of the synchronization frame MAC_SYNCF to the respective sensor unit SU.

The two instants t0_{EGSp} and t_{EGS_SYNCp} as well as the delay Δt_{EGS} are ascertained in the radio-frequency module RF_M based on the time information t_{EGS}, which the oscillator OSC1 and a connected leader clock LC provide.

In the synchronization frame MAC_SYNCF, items of information about the period duration Tₚ₋₁, i.e., an estimated up-to-date voltage period, which was ascertained using the last, for example, 10 to 30 voltage periods of the preceding measuring period p−1, and the time delay Δt_{EGSp-1}, which was ascertained at the beginning of the preceding measuring period p−1 but after the emission of the synchronization frame MAC_SYNCF, as well as the instant t0_{EGSp} of activation of the interrupt signal IS, i.e., for the zero crossing of the reference voltage U_{REF_H1}, are transmitted as a value from the leader clock LC.

The beginning of emission of the identification signal or SYNC frame MAC_SYNCF implicitly corresponds to the instant t_{EGS_SYNCp}=t0_{EGSp}+Δt_{EGSp}.

The information about the time delay Δt_{EGSp} arises in the exemplary embodiment only after the synchronization frame MAC_SYNCF has been emitted, and is transferred with the next synchronization frame MAC_SYNCF at the beginning of the measuring period p+1 to the respective sensor unit SU. Only then, i.e., one measuring cycle later, is compensation of the time delay Δt_{EGSp} for the measuring period p possible.

The radio-frequency module RF_M also provides a calculation apparatus CALC for the calculation of active and reactive power P and Q from corresponding voltages/voltage pointers and currents/current pointers.

Items of synchronization information are wirelessly transmitted via a radio-frequency link RF_L to one or more sensor unit(s) SU, and captured sensor data is transferred from the sensor units SU to the central unit CU, for example, in the form of a “unicast” data transfer UC_D, as described in more detail below. The sensor units SU are local control apparatuses respectively for data capture via corresponding sensor apparatuses.

The radio-frequency link RF_L can transmit a synchronization frame MAC_SYNCF via MAC layer-based “multicast” of the synchronization frame.

The sensor unit SU has a compensation apparatus DCOMP for the time delay Δt_{RF_L} in the radio-frequency link RF_L, as well as a local oscillator OSC2 and a connected follower clock FC, which provide time information t_{3NA}.

The time delay Δt_{RF_L} also takes into account the time delay in the receiver within the sensor unit SU through to the compensation apparatus DCOMP.

The time t_{3NA} is the local value of the follower clock FC in the local control apparatus, i.e., the sensor unit SU.

The capture of current pointers is synchronized in the sensor unit SU with the zero crossing of the reference voltage U_{REF_H1} in the central unit CU.

After compensation of the time delay of the radio-frequency link RF_L in the compensation apparatus DCOMP, the receive instants t0_{3NAp} and t0_{3NAp+1} of the synchronization frame MAC_SYNCF at the beginning of the measuring periods p and p+1 correspond to the corresponding transmission instants t_{EGS_SYNCp} and t_{EGS_SYNCp+1} in the central unit CU.

Using the instant t0_{EGSp} transmitted at the beginning of the measuring period p and the instant t0_{EGSp+1} transmitted at the beginning of the measuring period p+1 and the items of information about the time delay Δt_{EGSp} and the period duration Tₚ, firstly the instant t0_{EGSp+1} of the zero crossing of the reference voltage U_{REF_H1} is estimated in the sensor unit SU as the instant t0_{EGSp+1}*=t0_{3NAp}+t0_{EGSp+1}−t0_{EGSp}−Δt_{EGSp}, which corresponds to the estimated value from the follower clock FC in the sensor unit SU at the instant t0_{EGSp+1} in the central unit CU.

The zero crossing instant of the next period of the reference voltage U_{REF_H1} is then determined as the time t0_{3NAi+101}=t0_{EGSp+1}*+Tₚ.

The times with the index*point to an estimated value and correspond to the follower clock FC.

The times with the index 3NA correspond to times in the sensor unit SU and are formed by the follower clock FC.

The times with the index EGS correspond to times in the central unit CU and are formed by the follower clock LC.

The actual current measurement or current pointer ascertainment in the measuring period p+1 begins in the sensor unit SU at the instant t0_{3NAi+101}.

Sensor data SD in the form of current values I is captured by the sensor unit SU, processed and calculated as current pointer values, and subsequently optionally passed to an aggregation apparatus AGG for processing.

Sensor data SD can be, for example, alternating current values of the primary current in a power grid.

An aggregation can, for example, be taken to mean an averaging over a plurality of measured values, such as over a plurality of alternating current periods within a measuring period, where it is possible for other statistical methods to also be suitable for mapping measured values.

In the synchronization frame or frame MAC_SYNCF, items of information on its transmission instant in the form of a clock reading difference Δt_{EGSP} per “multi-cast” transmission are transferred to the sensor unit SU, and the period duration Tₚ₋₁ of the voltage characteristic U_{REF_H1} from the previous period p−1, and the instant t0_{EGSp} of activation of the interrupt signal IS, i.e., for the zero crossing of the reference voltage U_{REF_H1}, are co-transferred as the value t0_{EGSp} from the leader clock LC.

Items of information on the captured sensor data SD in the form of values relating to the complex current pointer I_{H1p} for the period with index p, as well as the current pointer I_{H1p}, are transferred, depending on the embodiment, as an individual value or as an aggregated value, by the sensor unit SU to the central unit CU by “unicast” transmission.

Voltage pointers U1ᵢ, U2ᵢ or U3ᵢ are formed in the central unit CU for each period i (the fundamental oscillation) of the grid alternating voltage u₁, u₂, and u₃ of a 3-phase system. The voltage pointers can also optionally be aggregated.

The voltages u₁, u₂, and u₃ can be, for example, voltages at phase conductors L₁, L₂, or L₃ of a power grid. One of the voltages, such as u₁, is selected as a reference voltage U_{REF_H1}.

For each measuring cycle p, which comprises, for example, 100 fundamental oscillation periods of the reference voltage U_{REF_H1}, a zero point crossing instant t0_{EGSp} of the reference voltage U_{REF_H1} is determined, which is phase-synchronous with the beginning of the first fundamental oscillation period of the reference voltage U_{REF_H1} and refers to the microsecond clock, present in the central unit CU, in the form of the leader clock LC with the time t_{EGS}.

The zero point crossing instant t0_{EGSp} refers to the up-to-date instant in the central control apparatus, while the zero point crossing instant t0_{EGSp-1} refers to the first zero point crossing instant of the preceding measuring period. In addition, the up-to-date grid voltage period duration Tₚ is determined.

As additional information, the instant can optionally also be determined in the form of a difference clock reading Δt_{EGSP-1} when the values for the clock reading Δt_{EGSP-2} and the period duration Tₚ₋₂ (not represented in the figure) in the preceding measuring period p−1 were transmitted to the sensor unit SU by means of an identification signal, what is known as the SYNC frame MAC_SYNCF.

The instant Δt_{EGSP-1} serves for correction of the temporal synchronism between the central unit CU and at least one sensor unit SU in the up-to-date measuring period p.

Apart from the zero point crossing instant t0_{EGSp}, the period duration Tₚ and the optional clock reading difference Δt_{EGSP-1}, the identification signal or the synchronization frame or “SYNC frame” MAC_SYNCF, which initiates the beginning of the measuring period p, also contains the number of the measuring period p itself, the number i of the first fundamental oscillation period of the reference voltage U_{REF_H1} in this measuring period and a grid source address of the central unit CU, which serves as a transmitter identification in the SYNC frame MAC_SYNCF.

The measuring period is defined based on a fundamental oscillation period clock, for example, in the form of a time unit.

In at least one or also all sensor unit(s) SU, in the measuring period p, based on the transmitted values for the zero point crossing instants t0_{EGSp} and t0_{EGSp-1}, in the central control apparatus CU, the up-to-date period duration Tₚ, and the optional instant of the deviation of the time delay Δt_{EGSP-1}, zero point crossing instants of the reference voltage U_{REF_H1} are synchronously determined in the central unit CU, with these instants corresponding to values of the respective leader clock LC.

Based on sensor data SD in the form of alternating current values, the current pointer I_{H1i} is formed for each individual harmonic period i within the measuring period p, and is transmitted with sensor data SD, either individually or as current pointers I_{H1p} aggregated over the measuring period p, to the central unit CU in a sensor data frame.

The same sensor data frame can also include, for example, the time stamp t_{3NA} of the respective sensor units SU, a number i of the first fundamental oscillation period of the reference voltage U_{REF_H1} in the measuring period p and optionally the numbers of the up-to-date measuring period p and/or the preceding measuring periods p−1, p−2.

After the sensor data SD has been received in the central unit CU, the associated, synchronously captured voltage and current pointers are used to calculate the active and reactive power values Pₚ and Qₚ.

In other words, in the exemplary embodiment of FIG. 5, the transmission instant of the SYNC frame MAC_SYNCF is provided as the start of the SYNC frame “header” MAC_SYNCF and additionally as a clock reading (difference) of the clock LC of the central unit CU via the reference signal transmitter REF_TX, preferably corresponding to a time resolution in the microsecond range.

In the following SYNC frame MAC_SYNCF, the zero point crossing t0_{EGSp} is thus transferred as the start of the synchronization frame MAC_SYNCF and as the up-to-date clock reading at the instant t0_{EGSp} of the zero point crossing and the difference of the clock readings Δt_{EGSp-1} between the preceding reference zero point crossing and the preceding transmission instant.

The signal propagation delay in the present exemplary embodiment is thus corrected in the respective sensor unit SU at the beginning of the up-to-date measuring period p in that from the preceding SYNC frame MAC_SYNCF of the measuring period p−1, the zero point crossing t0_{EGSp-1}, and from the SYNC frame MAC_SYNCF currently being received, the zero point crossing t0_{EGSp} from the up-to-date measuring period p and the transmission delay Δt_{EGSP-1} is used.

The time delay Δt_{RF_L} can be taken into account in the compensation by the DCOMP, although this is very small, and can also be ignored for the sake of simplicity. Here, two successive SYNC frames are therefore always necessary in order to ascertain the zero point crossing of the reference voltage U_{REF_H1} in the sensor unit SU.

The first exemplary embodiment can therefore also be described by the following words.

The method for the time synchronization of sensor units in a distributed system serves to determine reactive and active power in the central unit CU with at least one sensor unit SU and is based on a synchronization of the zero point crossing of the reference voltage between the central unit CU with a sensor unit SU, i.e., between the first, leader clock LC with a first, central oscillator OSC1 of the central unit CU and a second, follower clock FC with a second, local oscillator OSC2 of the respective sensor unit SU.

The starting instants and the following time characteristic for the calculation of current pointers in the sensor unit SU are synchronized with instants of the zero point crossing of the voltage fundamental oscillation.

This corresponds to a time synchronization between the central unit CU with the sensor unit SU, i.e., a coordination between the time basis t_{EGS} of a leader timer or clock LC within the central unit CU with a corresponding following time basis t_{3NA} of an internal, leader clock FC of the respective sensor unit SU.

It does not have to be an absolute time, rather it can refer to the individual voltage fundamental oscillation periods and/or to the clock periods of the respective clock LC, FC.

The sensor units SU each have one internal time unit FC, with this internal clock serving as time units which generate a time basis based on the numbered grid voltage periods and/or in a time unit (t_{3NA}) on a microsecond basis.

Sensor data SD in the form of current pointers is periodically captured by the sensor units SU with a specified temporal resolution of, for example, 1 microsecond, and/or provided with grid voltage period numbers, and is transmitted to the central unit CU via a radio grid RL_L.

An identification signal is emitted at regular intervals in the radio grid or on the radio-frequency link RF_L, such as every two seconds, one SYNC frame MAC_SYNCF from the central unit CU to the respective sensor unit SU. Receipt of the identification signal SYNC frame MAC_SYNCF is monitored in a respective sensor unit SU.

When a characteristic time feature of the identification signal is received, one up-to-date value respectively of the internal time unit FC of the respective sensor unit SU is stored with at least one transmitter identification contained in the identification signal, i.e., the data contained therein, such as the source address and/or authentication data from the RF module RF_M in the central unit CU, the characteristic time features contained therein, such as time stamp, time delay information, and/or number of the respective grid voltage period, and an up-to-date value of the particular time unit of the respective sensor unit SU, for example, from the receive time stamp of the SYNC frame MAC_SYNCF.

When capturing sensor data SD, a further, up-to-date value of the internal time unit FC of the respective sensor unit SU is stored, for example, one up-to-date time stamp respectively of the time unit of the respective sensor unit SU, as well as the number assigned to the respective grid voltage period and stored with this sensor data SD.

The zero crossing is therefore synchronized to the local time unit in the sensor, with only the zero crossing in the sensor having to be reproduced as accurately as possible, and a reference to the time unit in the central unit not being necessary.

At least the value of the internal time unit FC stored when the characteristic time feature of the identification signal is received, the associated transmitter identification of the identification signal MAC_SYNCF and the further value of the internal time unit stored when capturing the sensor data SD is assigned to the captured sensor data SD, are assigned and transferred together with the sensor data SD to the central unit CU.

This can occur via the data telegram, which is transmitted from the respective sensor unit SU to the central unit CU, which the number of the grid voltage period, to which the measurement data refers, as well as the associated address of the central unit CU, i.e., as the transmitter identification of the identification signal, to which it is transmitted, and an up-to-date time stamp of the time unit of the respective sensor unit SU, which is assigned when capturing data.

A reference time basis is derived using the transmitter identification, and a temporal relationship of the transferred sensor data SD of the respective sensor unit SU to the reference time basis is derived using the value of the internal time unit FC of the respective sensor unit SU stored when the characteristic time feature of the identification signal is received and the further value of the internal time unit FC of the respective sensor unit SU stored when capturing the sensor data SD, for example using the respective grid period number, from the received data telegram and/or the time stamp contained therein.

The central unit CU captures voltage values and phase values from at least one of the three phase conductors of a power grid, from which synchronization data t0_{EGSp} and Tp on the frequency or period duration as well as on the phasing of the voltage of at least one of the three phase conductors in relation to the instant of capture of the voltage values and phase values of the at least one of the three phase conductors is ascertained and transmitted to the sensor units SU.

The respective sensor unit SU captures the respective sensor data SD in the form of current values in relation to the synchronization data t0_{EGSp} and Tₚ, which is transferred to the central unit CU.

In the central unit CU, powers, in particular active and reactive powers, are calculated from the voltage values and current values.

The synchronization data t0_{EGSp} relating to the phasing of the voltage of at least one of the three phase conductors in relation to the instant of capture of the voltage values and phase values of the at least one of the three phase conductors is formed by the instant of transmission of the SYNC frame MAC_SYNCF from the central unit CU to the respective sensor unit SU.

The synchronization data t0_{EGSp}, Tₚ can be transmitted to the sensor units SU with the aid of the identification signal MAC_SYNCF.

The synchronization data t0_{EGSp}, Tₚ can be ascertained over more than one period of the voltage values and phase values of the three phases of the power grid, preferably from at least ten periods, particularly preferably from at least 100 periods.

The central unit CU can also capture voltage values and phase values from a phasing line of the power grid and first supplementary synchronization data Δt_{EGSp-1}, which was captured in a preceding timeframe, which lies before the up-to-date timeframe, in which the synchronization data t0_{EGSp}, Tₚ is captured.

The first supplementary synchronization data Δt_{EGSp-1} can be transmitted to the respective sensor unit SU, preferably with the aid of the identification signal MAC_SYNCF.

The first supplementary synchronization data Δt_{EGSp-1} can be taken into account by the respective sensor unit SU when the respective sensor data SD is captured.

In order to use the clock reading difference Δt_{EGSP-1}, it should be understood it is necessary for the synchronization to occur periodically.

The central unit CU thus captures voltage values and phase values from at least one of the three phase conductors of a power grid as current pointers over more than one fundamental oscillation period of the voltage.

The current pointers of the respective sensor unit SU are aggregated to form aggregated current pointers (I_{H1p}), and the aggregated current pointers I_{H1p} are transferred to the central unit CU.

In the central unit CU, powers are calculated from the voltage values and the aggregated current pointers (I_{H1p}).

In the respective sensor unit SU, the complex-value alternating current pointers or voltage pointers formed for an alternating current or an alternating voltage per alternating voltage fundamental oscillation period are averaged over a measuring period p, p+1, . . . and provided as a complex mean value with reference to the beginning of the measuring period.

Therefore the periods of the alternating voltage i as well as the measuring periods p, p+1, . . . are numbered in the central unit CU and transmitted to the sensor unit SU.

With reference to the number of the period of the alternating voltage it can therefore be applicable that the fundamental oscillation period of the reference voltage applies, or with reference to the local reference time of the internal time of the follower clock FC, which was transmitted to the sensor unit SU with the time of the central unit CU with the leader clock LC.

The successive measuring periods in the sensor unit SU are synchronized with those in the central unit CU by means of synchronization messages in order to communicate to the respective sensor unit SU the exact beginning timewise of the measuring period. However, the central unit CU can also capture voltage values and phase values of two or more of the three phase conductors of a power grid.

The current pointers can be aggregated by taking into account their respective amounts and phase values by averaging within the measuring periods p, with the current pointers being aggregated by taking into account the respective internal, follower time unit FC of the respective sensor unit SU by averaging over the measuring periods p.

The aggregation of the current pointers I_{H1p} can optionally take into account only those of the fundamental oscillation periods i of the grid voltage in which the values for the current pointers lie within predefined limit values, in order, for example, to disregard interference on the grid lines.

During the averaging over the measuring period p, consequently only the valid current pointers or voltage pointers of the individual alternating voltage fundamental oscillation periods are used.

Those current pointers or values, which are falsified, for example, due to an occurrence of interference pulses or energy recovery phases, are not incorporated in the averaging. Here, the effective averaging duration within the measuring period p is reduced, or the valid current/voltage pointers used for the averaging form a fragmented volume.

The aggregated current pointers I_{H1p} are transferred from the respective sensor unit SU to the central unit CU, in particular after the end of the respective measuring period with reference to the respective number of the fundamental oscillation at the beginning of the measuring period and optionally to the number of the up-to-date measuring period p and/or the preceding measuring periods p−1, p−2.

The measuring periods are synchronized in one or more sensor unit(s) SU and the central unit CU. As a result, the central unit CU establishes a clear temporal reference between received complex alternating current and voltage pointer mean values using the co-transferred items of reference information.

The current pointers can be ascertained over more than one fundamental oscillation period of the reference (phase) voltage, i.e., more than one voltage period of one of the three phases of the power grid, preferably from at least ten periods, particularly preferably from at least 100 periods.

The phase angles between individual phase voltages in a 3-phase 4-conductor distribution grid can be exactly 120° to each other, although also only the amount of the phase voltages can be different.

Based on this assumption, only the phasing of one of the phase voltages can serve as a reference for the measuring period p in the central unit CU and consequently after the synchronization in the respective sensor units CU.

After a complex alternating current pointer or the aggregated value has been received, by taking into account its assignment to the corresponding phase voltage, the complex alternating current pointer or its aggregated value can either be adopted directly or rotated about ±120° before it is multiplied by the amount of the phase voltage in order to calculate the mean active and reactive power.

The rotation of the alternating current pointer as a vector, which is determined in the Cartesian coordinate system via its complex value, can occur, for example, by multiplication via a rotation matrix.

Alternatively, the complex alternating current pointer or the aggregated value can be rotated immediately after its calculation in the sensor unit SU. For this, the assignment information on the respective phase voltage conductor must be continuously transmitted from the central unit CU to the sensor units SU, in particular when the reference voltage for the temporal synchronization of the measuring period in the central unit CU, and consequently in the sensor units SU, has changed.

If one or even two of the phase voltages fail(s), the next available phase voltage is used as the reference voltage for the synchronization of the measuring periods in central unit CU and in the sensor units SU. In such a case, the received complex alternating current pointers and/or alternating current pointers must be rotated in an appropriately adjusted manner before the power calculation.

The complex current pointers can be aggregated, for example, by applying the following correlations:

$${I}_{H {1}_{k} \_ RE} = \frac{\sqrt{2}}{{N}_{p}} {\sum }_{n = 0}^{{N}_{p} - 1} ( {x}_{( k \times {N}_{p} + n )} Sin \frac{2 π n}{{N}_{p}} )$$

$${I}_{H {1}_{k} \_ IM} = - \frac{\sqrt{2}}{{N}_{p}} {\sum }_{n = 0}^{{N}_{p} - 1} ( {x}_{( k \times {N}_{p} + n )} Cos \frac{2 π n}{{N}_{p}} )$$

where
Nₚ is the number of current samples of a fundamental oscillation period of the reference voltage within the measuring period p,
x_{(k×N}_{ₚ}₎, x_{(k×N}_{ₚ}₊₁₎, . . . , x_{(k×N}_{ₚ}_{+N}_{ₚ}₋₁₎ are the current samples/measurement data within the reference voltage period k,
IH1ₖ_RE is the real part of the complex current pointer IH1ₖ of the fundamental oscillation period k of the reference voltage within the measuring period p,
IH1ₖ_IM is the imaginary part of the complex current pointer IH1ₖ of the fundamental oscillation period k of the reference voltage within the measuring period p and
k is the index/the number of the reference voltage period k within the measuring period p.

It can be advantageous to perform an adjustment of the sampling instants of the sensor data of a corresponding sensor of the sensor unit to the respective period duration in order to more easily take into account changes in the period durations due to grid influences.

This can occur by way of a corresponding conversion of the measurement data or an adjustment of the sampling rate of the corresponding sensor of the sensor unit.

Further, the following correlations are to be applied:

$${I}_{H {1}_{p} \_ RE} = \frac{1}{{Mv}_{p}} {\sum }_{k = 0}^{Mp - 1} ( {V}_{k} \times {I}_{H {1}_{k} \_ RE} ) ,$$

$${I}_{H {1}_{p} \_ IM} = \frac{1}{{Mv}_{p}} {\sum }_{k = 0}^{M p - 1} ( {V}_{k} \times {I}_{H {1}_{k} \_ IM} ) ,$$

where
Mₚ is the number of measured values/current pointers I_{H1k} within the measuring period p,
Mᵥₚ≤Mₚ is the number of measured values/current pointers I_{H1k} with the validity attributes Vₖ=1 within the measuring period p, wherein those measured values I_{H1k} or those of the real parts I_{H1k_RE} and imaginary parts I_{H1k_IM}, which are affected by an energy generation during a fundamental oscillation period k=i+1, i+2, . . . , with the corresponding validity attributes Vₖ=0 are marked as invalid, and the valid measured values receive validity attributes Vₖ=1,
I_{H1k_RE} is the real part of the complex current pointer I_{H1k} of the fundamental oscillation period k of the reference voltage within the measuring period p,
I_{H1k_IM} is the imaginary part of the complex current pointer I_{H1k} of the fundamental oscillation period k of the reference voltage within the measuring period p,
I_{H1p_RE} is the real part of the complex aggregated current pointer I_{H1p} for the measuring period p and
I_{H1p_IM} is the imaginary part of the complex aggregated current pointer I_{H1p} for the measuring period p.

The measured values IH1ₖ_RE and IH1ₖ_IM calculated for each individual period are subsequently aggregated over the measuring period p respectively to form the desired current pointers IH1ₚ_RE or IH1ₚ_IM, as stated previously.

The values for Mₚ are normally selected as 100 fundamental oscillations per measuring period for a 50 Hz system, or 120 fundamental oscillations per measuring period for a 60 Hz system.

A measuring period p can also comprise fewer than 100 or 120 fundamental oscillations due to possible fluctuations in the grid frequency.

The aggregated current values IH1ₚ_RE or IH1ₚ_IM are then transferred as aggregated, complex current pointers IH1ₚ to the central unit CU.

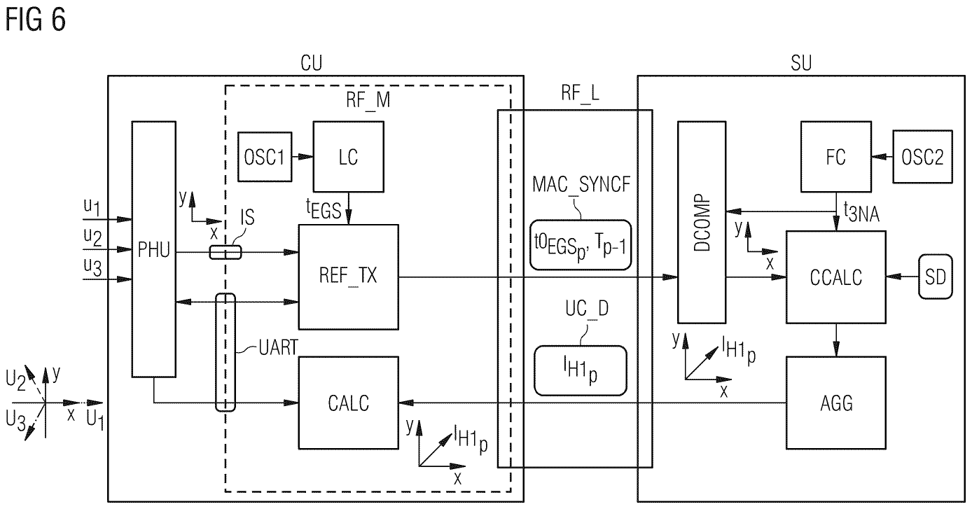

FIG. 6 shows a second exemplary block diagram of an embodiment of the invention.

The information about the clock reading difference Δt_{EGSP-1} in the identification signal or SYNC frame MAC_SYNCF of the measuring period p is not transferred in this exemplary embodiment.

It is assumed that the SYNC frame MAC_SYNCF is emitted in the central unit CU and, in particular, in the transmitter REF_TX, synchronously with zero point crossing instant of the reference voltage U_{REF_H1} and solely the propagation delay correction for receiving the SYNC frame MAC_SYNCF takes place in the sensor unit SU to establish the temporal synchronism between the central unit CU and the respective sensor units SU.

In the presently contemplated exemplary embodiment, during transmission by the reference signal transmitter REF_TX of the central unit CU, a clock reading is delivered at which emission of the SYNC frame header MAC_SYNCF should begin.

In contrast to the first exemplary embodiment, the time delay Δt_{EGSp} is at the beginning of a measuring period p between the instant t0_{EGSp} of activation by the interrupt signal IS, i.e., for the zero crossing of the reference voltage U_{REF_H1}, and the instant t_{EGS_SYNCp} of emission of the synchronization frame MAC_SYNCF to the respective sensor unit SU is negligible and therefore does not have to be transferred.

In the synchronization frame MAC_SYNCF, solely information about the period duration Tₚ₋₁ is transferred, i.e., the estimated up-to-date voltage period, which was ascertained, for example, using the last 10 to 30 voltage periods of the preceding measuring period p−1.

The beginning of emission of the SYNC frames MAC_SYNCF implicitly corresponds to the instant t_{EGS_SYNCp}≈t0_{EGSp} because the amount of the delay Δt_{EGSp} is usually negligible.

This means that the receiving-side time delay of the SYNC frame MAC_SYNCF for the measuring period p and the synchronization between the central unit CU and the respective sensor unit SU is compensated for at the very beginning of the same measuring cycle p.

The SYNC frame MAC_SYNCF is emitted by the central unit CU, delayed by a fundamental oscillation period, exactly synchronously with the zero point crossing instant of the reference voltage U_{REF_H1}.

The information about the instant t0_{EGSp} is implicitly transferred with the emission of the SYNC frame MAC_SYNCF.

No further clock reading of the central unit CU has to be transferred in the SYNC frame MAC_SYNCF in this example.

The RF receiver unit in the sensor unit SU provides the clock reading at the receive instant of the SYNC frame header MAC_SYNCF.

With receipt of the SYNC frame MAC_SYNCF at the instant t0_{EGSp} of the respective sensor unit, the time t0_{EGSp}*=t0_{3NAp}.

The signal propagation delay over the radio-frequency link RF_L is corrected in the respective sensor unit SU in the present exemplary embodiment in that the zero point crossing instant of the reference voltage U_{REF_H1} is adopted directly as a corrected receive instant of the SYNC frame header.

In this method, the zero point crossing instant of the reference voltage U_{REF_H1} can be ascertained in the sensor unit SU from each SYNC frame MAC_SYNCF.

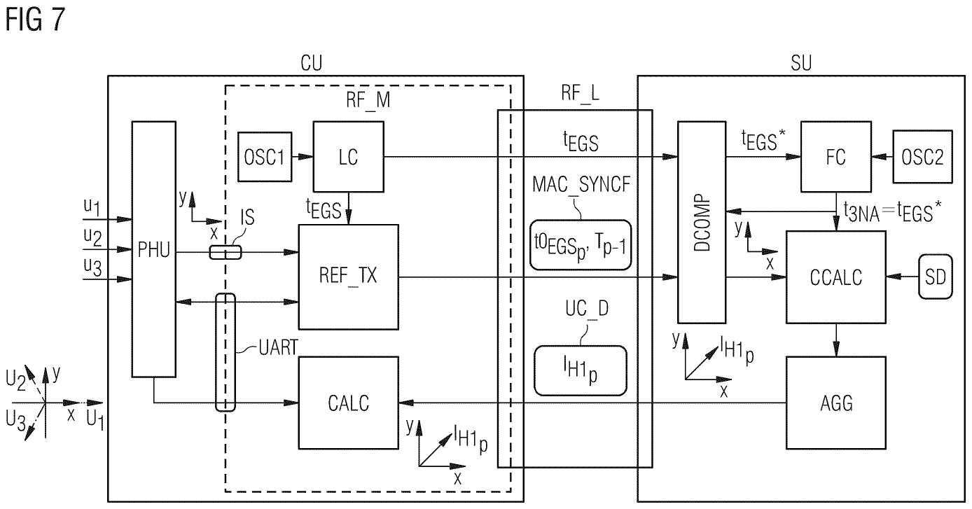

FIG. 7 shows a third exemplary embodiment of the invention in the form of a block diagram in which the time value t_{EGS} of the clock in the central unit CU is transferred to the sensor unit SU via separate time synchronization frames and after a propagation delay correction of the time basis t_{3NA} in the sensor unit SU, is adopted by the value t_{EGS} of the time basis of the central unit CU.

This correction of t_{3NA}=t_{EGS} is possible because separate time synchronization frames are prepared in advance in the central unit CU and are emitted to the sensor unit SU at the instants contained in the frames.

This makes it possible to not transmit the previously described SYNC frames MAC_SYNCF in the central unit CU at the start of each measuring period p synchronously with the zero point crossing-instant t0_{EGSp} of the reference voltage U_{REF_H1}, but rather within the first period of the reference voltage U_{REF_H1} since the information about the zero point crossing instant is contained in the value t0_{EGSp} which refers to the time t_{EGS} as well as the continuously synchronized time basis t_{3NA} of the sensor unit SU.

Consequently, the transfer in the SYNC frame MAC_SYNCF of the instant value of the transmission delay Δt_{EGSP-1} is not necessary and the time interval between the beginning of the measuring period p and the previous time reference point of t0_{EGSp-1} from the first exemplary embodiment is shortened in FIG. 3 to the reference point of t0_{EGSp}.

In other words, the central unit CU can also have an internal, central time unit LC whose value forms second supplementary synchronization data t_{EGS}, and the second supplementary synchronization data can be transmitted to the respective sensor unit SU, preferably with the aid of the identification signal MAC_SYNCF, and the second supplementary synchronization data t_{EGS} can be taken into account by the respective sensor unit SU when the respective sensor data SD is captured.

The current values of the respective sensor unit SU can be aggregated to form aggregated current pointers I_{H1p}, and the aggregated current pointer I_{H1p} can be transferred to the central unit CU, and powers are calculated in the central unit CU from the voltage values and the aggregated current pointers I_{H1p}.

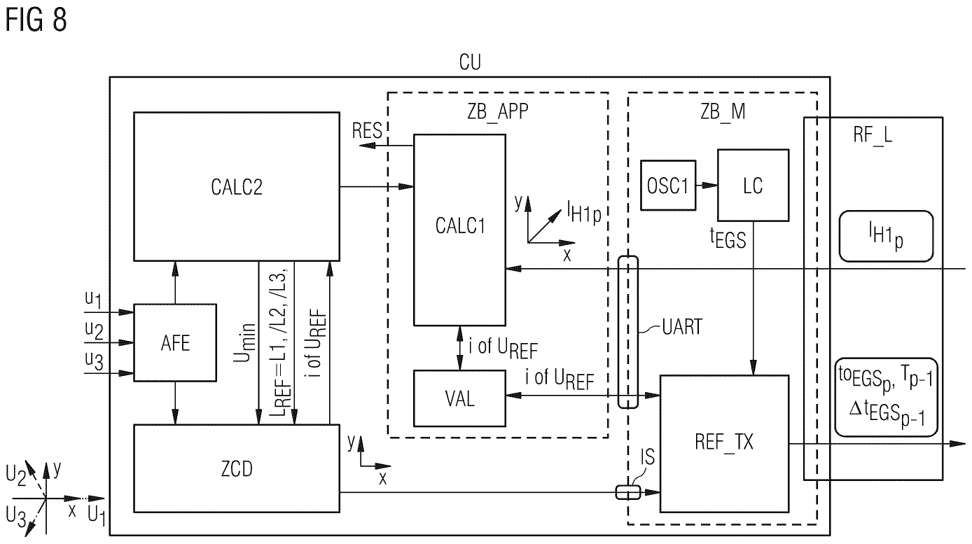

FIG. 8 shows a detailed view of the central unit CU of the invention.

All three cited exemplary embodiments can be used if the central unit CU and at least one sensor unit SU communicate directly via wired connection or via a plurality of nodes/hops, such as in the case of an Ethernet-based “daisy chain”.

The propagation delay correction should occur on the part of the respective sensor unit SU when the SYNC frame MAC_SYNCF is received as a function of the position of the sensor unit SU in the daisy-chain.

The propagation delay correction values are preferably determined for each sensor unit SU in a periodic ascertainment of a propagation delay correction value or at the beginning of communication, i.e., for example, by the emission of periodic propagation delay measurement frames

An analog frontend AFE samples the voltages U2, U2, U3.

A zero crossing detection apparatus ZCD detects zero crossings in the time characteristic of the reference voltage U_{REF_H1} and counts the voltage cycles of the respective voltage.

The radio-frequency module RF_M can be formed, for example, by a “Zigbee” module ZB_M and a “Zigbee” application ZB_APP, with the latter delivering results RES for current, voltage, power.

A calculation apparatus CALC1 serves to calculate active power P and reactive power Q from corresponding voltages and currents, or from voltage pointers and current pointers.

A calculation apparatus CALC2 serves
to calculate voltage values from items of amount and phase information, with the bullet point corresponding to the last, preceding bullet point,
to provide the measuring periods of a reference voltage U_{REF_H1} counted in the zero crossing detection apparatus ZCD,
to determine a reference line LREF from grid phase conductors L1, L2, L3 of the power grid,
to determine a minimum voltage U_{MIN}, below which the voltage zero point crossings are not determined or counted in order to improve an error rate,
for optional determination of a phase sequence of grid voltages u1, u2, u3 in the form of voltage pointers U1, U2, U3 of the grid voltage,
for a determination of voltage pointers U1, U2, U3 from the grid voltages u1, u2, u3.

The calculations of the calculation apparatus CALC2 are periodically checked over measuring cycles by an appropriate validation apparatus VAL, in particular with regard to coordination of the voltage and current period numberings.

The data of the apparatus on reference phase transfer PHU is distributed accordingly to a radio-frequency module RF_M with the aid of the transmitter or receiver UART in the central unit CU.

An interrupt signal IS for zero crossing in the reference voltage U_{REF_H1} is provided to a reference signal transmitter REF_TX within the radio-frequency module RF_M which, in turn, receives information from a central oscillator OSC1 and a leader clock LC in respect of the zero point crossing of the reference voltage t0_{EGS} and a time delay when emitting sync frames MAC_SNCF Δt_{EGS}.

The minimum voltage U_{MIN} can ensure that only one minimum permissible voltage is taken into account in the subsequent evaluation for power calculation to improve an error rate.

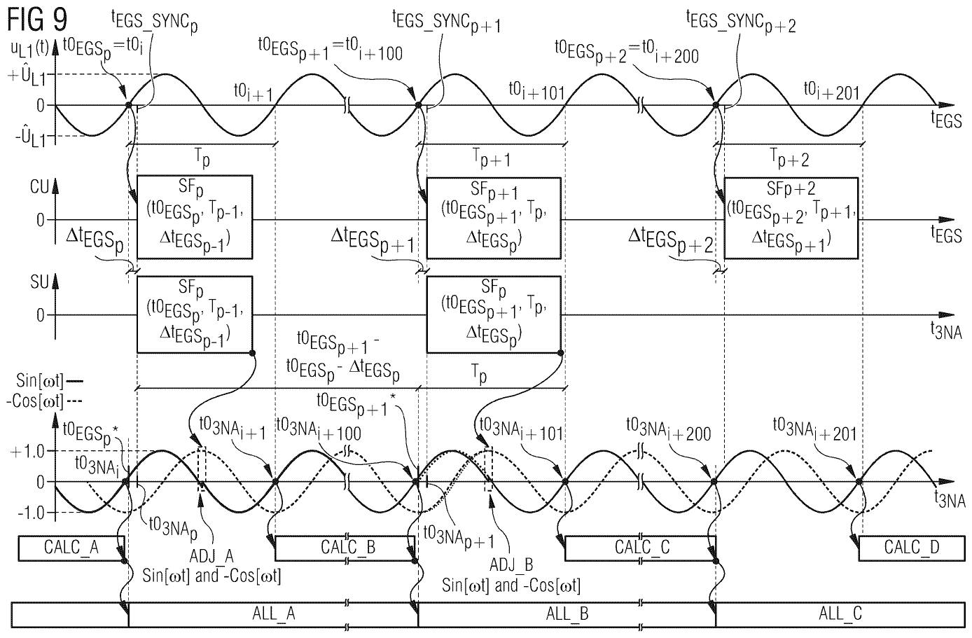

FIG. 9 shows an example of a signal characteristic in the energy distribution grid, with the time sequence of the data capture of the sensor data SD being shown.

The time ranges ALL_A, ALL_B, ALL_C show the transfers by all sensor units SU of the respective currents for the measuring periods p−1, p, p+1, p+2 to the central unit CU.

The time ranges CALC_A, CALC_B, CALC_C, CALC_D show the respective calculations of the aggregated currents for the measuring periods p−1, p, p+1, p+2 in the sensor unit SU.

The time ranges ADJ_A, ADJ_B show the adjustments of the time units of the respective sensor units SU from the synchronization data of the respective SYNC frames SFₚ₋₁, SFₚ, SFₚ₊₁, SFₚ₊₂, which are generally referred to as SYNC frame MAC_SYNCF.

The SYNC frame SFₚ₋₁ is not represented in the figure.

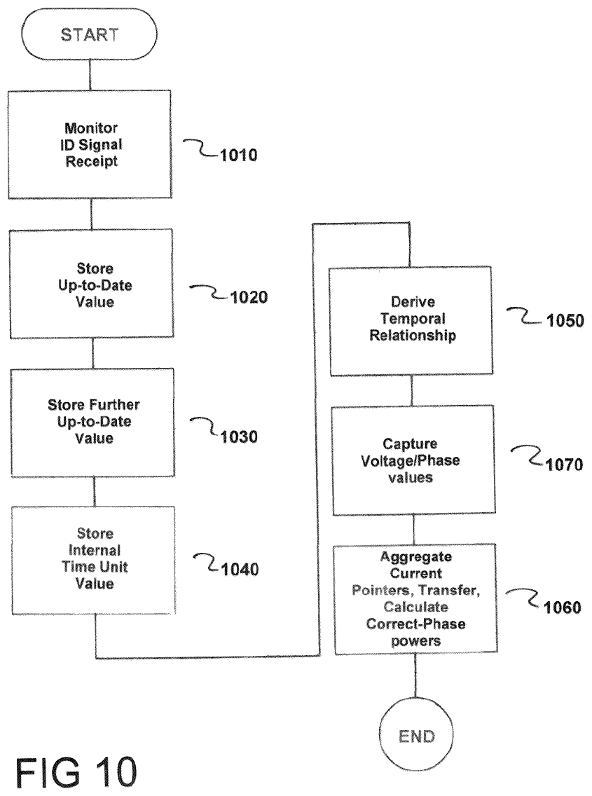

FIG. 10 is a flowchart of the method for time synchronization of sensor units SU in a distributed system, where the sensor units SU each respectively having one internal time unit FC, sensor data SD is captured by the sensor units SU and transmitted to a central unit CU via a radio grid, and an identification signal MAC_SYNCF is emitted at regular intervals in the radio grid. The method comprises monitoring receipt of the identification signal MAC_SYNCF in a respective sensor unit SU, as indicated in step 1010.

Next, one up-to-date value respectively of the internal time unit FC of the respective sensor unit SU with at least one transmitter identification contained in the identification signal is stored when a characteristic time feature of the identification signal MAC_SYNCF is received, as indicated in step 1020.

Next, a further, up-to-date value of the internal time unit FC of the respective sensor unit SU when capturing sensor data SD is stored, as indicated in step 1030.

Next, at least a value of the internal time unit is stored when the characteristic time feature of the identification signal is received, as indicated in step 1040. In accordance with the invention, an associated transmitter identification of the identification signal, and a further value of the internal time unit FC stored when capturing the sensor data SD are assigned to the captured sensor data SD and are transferred together with the sensor data SD to the central unit CU.

Next, a temporal relationship of the transferred sensor data SD of the respective sensor unit SU to the reference time basis is derived, utilizing the transmitter identification, a reference time basis and utilizing the value of the internal time unit FC of the respective sensor unit SU stored when the characteristic time feature of the identification signal is received and the further value of the internal time unit FC of the respective sensor unit SU stored when capturing the sensor data SD, as indicated in step 1050.

Next, the central unit CU captures voltage values and phase values from at least one of the three phase conductors of a power grid as at least one of voltage pointers and current pointers to more than one fundamental oscillation period of the voltage, as indicated in step 1060.

Next, the current pointers of the respective sensor unit SU are aggregated to form aggregated current pointers I_{H1p}, and instead of the sensor data, the aggregated current pointers I_{H1p} is transferred to the central unit CU, and calculating correct-phase powers are calculated in the central unit CU from the voltage values and the aggregated current pointers I_{H1p}, as indicated in step 1070.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for time synchronization of sensor units in a distributed system, the sensor units each respectively having one internal time unit, and sensor data being captured by the sensor units and transmitted to a central unit via a radio grid, and an identification signal being emitted at regular intervals in the radio grid, the method comprising:
monitoring receipt of the identification signal in a respective sensor unit;
storing one up-to-date value respectively of the internal time unit of the respective sensor unit with at least one transmitter identification contained in the identification signal when a characteristic time feature of the identification signal is received;
storing a further, up-to-date value of the internal time unit of the respective sensor unit when capturing sensor data;
storing at least a value of the internal time unit when the characteristic time feature of the identification signal is received, an associated transmitter identification of the identification signal, and a further value of the internal time unit stored when capturing the sensor data being assigned to the captured sensor data and being transferred together with the sensor data to the central unit;
deriving a temporal relationship of the transferred sensor data of the respective sensor unit to the reference time basis, utilizing the transmitter identification, a reference time basis and utilizing the value of the internal time unit of the respective sensor unit stored when the characteristic time feature of the identification signal is received and the further value of the internal time unit of the respective sensor unit stored when capturing the sensor data;
capturing, by the central unit, voltage values and phase values from at least one of the three phase conductors of a power grid as at least one of voltage pointers and current pointers to more than one fundamental oscillation period of the voltage; and
aggregating the current pointers of the respective sensor unit to form aggregated current pointers, and instead of the sensor data, transferring the aggregated current pointers to the central unit, and calculating in the central unit correct-phase powers from the voltage values and the aggregated current pointers.

2. The method as claimed in claim 1, wherein the current pointers are aggregated by taking into account their respective amounts, including the phase values, by averaging within the measuring periods.

3. The method as claimed in claim 1, wherein the current pointers are aggregated by taking into account the respective internal time unit of the respective sensor unit by averaging within the measuring periods.

4. The method as claimed in claim 1, wherein the aggregation of the current pointers takes into account only those periods in which the values for the current pointers lie within predefined limit values.

5. The method as claimed in claim 1, wherein the aggregated current pointers are transferred from the respective sensor unit to the central unit.

6. The method as claimed in claim 1, wherein the current pointers are ascertained over more than one period of the voltage values and phase values of the three phases of the power grid.

7. The method as claimed in claim 6, wherein the current pointers are ascertained from at least ten periods of the voltage values and phase values of the three phases of the power grid.

8. The method as claimed in claim 7, wherein the current pointers are ascertained from at least 100 periods of the voltage values and phase values of the three phases of the power grid.

9. The method as claimed in claim 1, wherein the central unit captures voltage values and phase values from at least one of the three phase conductors of a power grid, from which synchronization data on the frequency or period duration, as well as on phasing of the voltage of at least one of the three phase conductors in relation to the instant of capture of the voltage values and phase values of the at least one of the three phase conductors is ascertained and transmitted to the sensor units; and
wherein the respective sensor unit captures the respective sensor data as current values in relation to the synchronization data;
wherein the sensor data is transferred to the central unit; and
wherein powers are calculated in the central unit from the voltage values and current values.

10. The method as claimed in claim 1, wherein the synchronization data relating to the phasing of the voltage at least one of the three phase conductors in relation to an instant of capture of the voltage values and phase values of the at least one of the three phase conductors is formed by an instant of transmission from the central unit to the respective sensor unit.

11. The method as claimed in claim 1, wherein the synchronization data is transmitted to the sensor units aided by the identification signal.

12. The method as claimed in claim 1, wherein the synchronization data is ascertained over more than one period of the voltage values and phase values of the three phases of the power grid.

13. The method as claimed in claim 12, wherein the synchronization data is ascertained over at least ten periods of the voltage values and phase values of the three phases of the power grid.

14. The method as claimed in claim 13, wherein the synchronization data is ascertained over at least 100 periods of the voltage values and phase values of the three phases of the power grid.

15. The method as claimed in claim 1, wherein the central unit captures voltage values and phase values from a phase conductor of the power grid and first supplementary synchronization data on the time delay when the identification signal is emitted, said data being captured in a preceding timeframe, which lies before the up-to-date timeframe in which the synchronization data is captured;
wherein the first supplementary synchronization data is transmitted to the respective sensor unit aided by the identification signal; and
wherein the first supplementary synchronization data is taken into account by the respective sensor unit when the respective sensor data is captured.

16. The method as claimed in claim 1, wherein the central unit further includes an internal central time unit whose value forms second supplementary synchronization data;
wherein the second supplementary synchronization data is transmitted to the respective sensor unit aided by the identification signal; and
wherein the second supplementary synchronization data is taken into account by the respective sensor unit when the respective sensor data is captured.

17. A distributed system for time synchronization of sensor units, the distributed system comprising:
a central unit; and
memory;
wherein the distributed system is configured to:
monitor receipt of the identification signal in a respective sensor unit;
store one up-to-date value respectively of the internal time unit of the respective sensor unit with at least one transmitter identification contained in the identification signal when a characteristic time feature of the identification signal is received;
store a further, up-to-date value of the internal time unit of the respective sensor unit when capturing sensor data;
store at least a value of the internal time unit stored when the characteristic time feature of the identification signal is received, an associated transmitter identification of the identification signal, and a further value of the internal time unit stored when capturing the sensor data being assigned to the captured sensor data and being transferred together with the sensor data to the central unit;
derive a temporal relationship of the transferred sensor data of the respective sensor unit to the reference time basis, utilizing the transmitter identification, a reference time basis and utilizing the value of the internal time unit of the respective sensor unit stored when the characteristic time feature of the identification signal is received and the further value of the internal time unit of the respective sensor unit stored when capturing the sensor data;
capture, by the central unit, voltage values and phase values from at least one of the three phase conductors of a power grid as at least one of voltage pointers and current pointers to more than one fundamental oscillation period of the voltage; and
aggregate the current pointers of the respective sensor unit to form aggregated current pointers, and instead of the sensor data, transfer the aggregated current pointers to the central unit, and calculate in the central unit correct-phase powers from the voltage values and the aggregated current pointers.
